(19) United States
(12) Patent Application Publication
(10) Pub. No.: US 2007/0099105 A1
(43) Pub. Date: May 3, 2007

(54) Non-magnetic toner for developing electrostatic image

(75) Inventor: Muneharu Itoh, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, Tokyo (JP)

(21) Appl. No.: 11/589,880

(22) Filed: Oct. 31, 2006

(30) Foreign Application Priority Data
Oct. 31, 2005 (JP) 2005-316733

(51) Int. Cl. G03G 9/08

(52) U.S. Cl. 430/111.4; 430/137.15

(57) ABSTRACT

The present invention aims to provide a non-magnetic toner for developing electrostatic image which is able to perform stable high-quality printing in spite of environmental changes in, for example, temperature, humidity and so on. The non-magnetic toner for developing electrostatic image comprising a colored particle, produced by a method comprising a step of forming a droplet in an aqueous dispersion medium containing a dispersion stabilizer, wherein a volume average particle diameter of the toner for developing electrostatic image is from 3 to 10 μm and an amount of adsorbed moisture of the non-magnetic toner for developing electrostatic image at 32° C. and a relative humidity of 80% is from 0.1 to 0.25 wt %.

### BACKGROUND OF THE INVENTION

1. Field of the Invention

The present invention relates to a non-magnetic toner for developing electrostatic image used for development of a latent image of electrostatics in an electrophotography, an electrostatic recording method, an electrostatic printing process or the like. Hereinafter, “a toner for developing electrostatic image” may be simply referred as “a toner,” and “a non-magnetic toner for developing electrostatic image” may be referred as “a non-magnetic toner.”

2. Description of the Related Art

A method of forming desired images by developing a latent image of electrostatic with a toner for developing electrostatic image is extensively used.

For example, in an electrophotography, a latent image of electrostatics formed on a photosensitive member is developed by a toner to obtain a toner image. The toner image is transferred to a recording material such as paper, an OHP sheet or the like and fixed on the recording material, and thus obtained a printed product.

A toner contains a colored particle and, if necessary, an external additive and other particles.

Generally, toners are classified into a magnetic toner and a non-magnetic toner depending on whether a colored particle contains a magnetic powder or not. In particular, the non-magnetic toner can suffice high-speed printing and can be used as a colored toner, which requires high resolution and reproduction of a clear color tone, since it does not contain a magnetic powder, which is dark color.

Also, the colored particle, which is a main content of the toner, has various production methods. For example, there may be a pulverizing method, a polymerization method, a solution suspension method and so on.

The pulverizing method is a method of producing a colored particle by pulverizing and classifying a solid of a colored resin obtained by mixing and kneading a binder resin and a colorant.

On the other hand, as a polymerization method, for example, there may be a suspension polymerization method, wherein a droplet of a polymerizable monomer composition containing a polymerizable monomer and a colorant is formed and is polymerized so as to produce a colored particle, an emulsion polymerization agglomeration method, wherein a colored particle is produced by aggregating a microparticle of a binder resin, which is obtained by polymerizing an emulsified polymerizable monomer, with a colorant and so on, or the like.

Also, the solution suspension method is a method of producing a colored particle by forming a droplet of a solution of toner components such as a binder resin, a colorant and so on in an organic solvent and removing the organic solvent.

While the colored particle obtained by the pulverizing method has an indeterminate form (shape), the colored particle obtained by the suspension polymerization method, the emulsion polymerization agglomeration method or the solution suspension method is close to a spherical shape and has a small particle diameter and a sharp particle size distribution.

Particularly, from the viewpoint of improving an image quality such as image reproducibility, fineness or the like, a toner whose shape and particle diameter distribution are highly controlled such as the toner obtained by the methods mentioned above has been used.

Further, improvement in environmental stability is required for the toner from the viewpoint of preventing deterioration of an image quality due to environmental changes in temperature, humidity or the like.

A toner for developing electrostatic image is charged between a toner particle and development devices such as a developing blade or the like, between toner particles or between a toner particle and a carrier, and then the toner is supplied on a photosensitive member which contains a latent image of electrophotography.

The appropriately charged toner of an amount in accordance with a charge density of the latent image of electrostatics attaches to the photosensitive member so as to form a high-quality image. To the contrary, if charging characteristics such as a charge amount or charge uniformity of the toner is inadequate, a high-quality image cannot be formed.

Generally, a charge amount of a toner is likely to be changed significantly depending on environmental changes. Therefore, it is difficult to maintain stable high-quality printing in a wide range of environment, and environmental stability of the toner becomes inferior.

It is known that the environmental stability and the charging characteristics of a toner are related to an amount of moisture content in the toner.

Japanese Patent Application Laid-Open (JP-A) No. Hei. 8(1996)-334924 discloses a method of producing a toner, wherein after an oil phase comprising a polymerizable monomer, a charge control agent having a moisture content of 0.1 to 3.0 wt % and other additives required to produce a toner is dispersed in a water phase, a polymerization reaction is performed to form a toner.

However, JP-A No. Hei. 8-334924 only mentions to adjust the moisture content of the charge control agent used for production of the toner preliminarily before producing the toner.

Also, JP-A No. 2004-78055 discloses a toner, wherein an average circularity of the toner is 0.94 or more, and a difference M2−M1=ΔM between the amount M1 of adsorbed moisture at an arbitrary relative humidity in an adsorption process and the amount M2 of adsorbed moisture in a desorption process at the same humidity on an adsorption/desorption isothermal line at 30° C. is 0.06 mass % or less. Further, JP-A No. 2004-78055 mentions that a preferable range of amount M3 of adsorbed moisture of the toner at 30° C. and a humidity of 80% is 0.01 to 0.4 mass %.

However, the toner disclosed in JP-A No. 2004-78055 is a toner produced by the pulverizing method, and only a magnetic toner containing a magnetic powder as a colorant is disclosed as a toner having a small amount of adsorbed moisture. Hence, with regard to the non-magnetic toner produced by the pulverizing method, JP-A No. 2004-78055 only discloses a preferable range of an amount of adsorbed moisture. Also, in JP-A No. 2004-78055, a non-magnetic toner actually obtained in Example is only a toner which has the amount M3 of adsorbed moisture of 0.28 mass %.

The present invention has been achieved in light of the above-mentioned circumstances. An object of the present invention is to provide a non-magnetic toner for developing electrostatic image which can maintain a stable high-quality printing in a wide range of environment and is excellent in environmental stability.

### SUMMARY OF THE INVENTION

As the result of diligent researches made to attain the above object, the inventor of the present invention obtained a knowledge that a non-magnetic toner for developing electrostatic image having a specific range of an amount of adsorbed moisture on the surface of a colored particle under an environment of a high-temperature and a high-humidity can attain the above object.

The present invention is based on the above knowledge and provides a non-magnetic toner for developing electrostatic image comprising a colored particle, produced by a method comprising a step of forming a droplet in an aqueous dispersion medium containing a dispersion stabilizer, wherein a volume average particle diameter of the toner for developing electrostatic image is from 3 to 10 μm and an amount of adsorbed moisture of the non-magnetic toner for developing electrostatic image at 32° C. and a relative humidity of 80% is from 0.1 to 0.25 wt %.

The non-magnetic toner having the above amount of adsorbed moisture has a small change in charging characteristics due to environmental changes and is able to stably obtain an appropriate charge property in spite of environmental changes so as to maintain stable high-quality printing in a wide range of environment, which means that the toner is excellent in environmental stability.

It is preferable that an amount of adsorbed moisture of the non-magnetic toner for developing electrostatic image of the present invention at 23° C. and a relative humidity of 50% is from 0.05 to 0.18 wt %.

Also, as for the non-magnetic toner for developing electrostatic image of the present invention, it is preferable that a difference between the amount of adsorbed moisture at 32° C. and the relative humidity of 80% and the amount of adsorbed moisture at 23° C. and the relative humidity of 50% is 0.15 wt % or less.

A dispersion state of a colorant particle on the section of the colored particle may be preferable when meeting the following conditions (1) and (2) since the amount of adsorbed moisture of the toner can be controlled within the above ranges:

(1) a dispersion average particle diameter of the colorant particle is 80 nm or less; and

(2) a number-based percentage of the colorant particle having a particle diameter of 400 nm or more is 5% or less.

It is preferable that the colored particle is produced by a suspension polymerization method and an average circularity of the colored particle is from 0.95 to 0.995.

As for the non-magnetic toner for developing electrostatic image of the present invention, it is preferable that an absolute value of a charge amount |Q/M| of the toner is in the range from 10 to 70 μC/g.

Also, by using the non-magnetic toner for developing electrostatic image of the present invention, a ratio of a charge amount of the toner at 10° C. and a relative humidity of 20% with respect to a charge amount of the toner at 32° C. and a relative humidity of 80% can be adjusted in the range from 1.0 to 3.5.

The above-mentioned non-magnetic toner for developing electrostatic image of the present invention is excellent in environmental stability, produces no fog under various environments from low temperature and humidity to high temperature and humidity, and can perform high quality printing with high image density.

### BRIEF DESCRIPTION OF THE DRAWINGS

In the accompanying drawing,

FIG. 1 is a view showing a constitutional example of an electrophotographic apparatus to perform an image forming method in the present invention.

The numerical symbols in each figure refer to the following: 1: a photosensitive dram, 2: a charging roller, 3: a light radiation device, 4: a development device, 5: a transfer roller, 6: a cleaning blade, 7: a fixing device, 7a: a heating roller, 7b: a support roller, 8: a casing, 8a: a toner vessel, 9: a developing roller, 10: a blade for the developing roller, 11: a supply roller, 12: a stirring vane, 13: a toner, and 14: a recording material.

### DETAILED DESCRIPTION OF THE INVENTION

A non-magnetic toner for developing electrostatic image of the present invention is a non-magnetic toner for developing electrostatic image comprising a colored particle, produced by a method comprising a step of forming a droplet in an aqueous dispersion medium containing a dispersion stabilizer, wherein a volume average particle diameter of the toner for developing electrostatic image is from 3 to 10 μm and an amount of adsorbed moisture of the non-magnetic toner for developing electrostatic image at 32° C. and a relative humidity of 80% is from 0.1 to 0.25 wt %.

A charge phenomenon of a toner mainly occurs on the surface of a colored particle. If an amount of moisture of the surface of a colored particle changes in accordance with environmental changes in temperature, humidity or the like, charging characteristics are likely to change due to the change in amount of moisture. If charging characteristics of a toner changes to cause decrease or unevenness in a charge amount of the toner, desired development of a latent image of electrostatics on a photosensitive member cannot be performed, and problems such as an insufficient density of an image, unevenness, a fog and so on can be caused.

As for these problems, the non-magnetic toner for developing electrostatic image of the present invention comprising a colored particle having the volume average particle diameter from 3 to 10 μm, and having the above range of the amount of absorption moisture at 32° C. and a relative humidity of 80%, has a small change in charging characteristics due to environmental changes and is able to stably obtain an appropriate charge property in spite of such environmental changes.

Hence, the non-magnetic toner for developing electrostatic image of the present invention is excellent in environmental stability, produces no fog under various environments from low temperature and humidity to high temperature and humidity, and can perform high quality printing with high image density.

As moisture of a toner, there may be moisture adsorbed on the surface of a particle such as a colored particle or the like and moisture contained inside of the particle.

The Karl Fischer's method, which is conventionally mostly used for defining an amount of moisture of a toner, is a method of measuring an entire amount of moisture of a toner particle. To the contrary, the present invention is not intended to specify the entire amount of moisture of a toner particle but is to specify an amount of moisture adsorbed on the surface of a toner particle.

It is known that adsorption of moisture is dependent on the size of a surface area of a toner, thus generally an amount of adsorbed moisture increases as the surface area becomes large. Also, the surface area of the toner significantly changes by a particle diameter. Hence, the most suitable amount of adsorbed moisture to obtain a high environmental stability largely varies by a volume average particle diameter of the toner.

Also, magnetic powders such as ferrite, nickel and so on, which are generally used for a magnetic toner, has a large specific gravity. Accordingly, a non-magnetic toner not containing the magnetic powder has a small specific gravity compared to the magnetic toner containing the magnetic powder in a colored particle. Generally, the specific gravity of the magnetic toner is from 1.6 to 2.0 and the specific gravity of the non-magnetic toner is from 1.1 to 1.2. The amount of adsorbed moisture can be represented by weight of adsorbed moisture with respect to weight of a toner. Hence, the most suitable value of an amount of adsorbed moisture of the non-magnetic toner becomes smaller than that of the magnetic toner.

Taking these points into account, the present invention specifies the suitable amount of adsorbed moisture for the non-magnetic toner containing a colored particle which has a relatively small particle diameter.

In the present invention, as a method of producing a colored particle including the process of forming a droplet in an aqueous dispersion medium containing a dispersion stabilizer, there may be the suspension polymerization method, wherein a droplet of a polymerizable monomer composition is formed in an aqueous dispersion medium containing a dispersion stabilizer and is polymerized; the polymerization method such as an emulsion polymerization agglomeration method, wherein a microparticle of a resin, which is obtained by polymerizing an emulsified polymerizable monomer, is aggregated with a colorant and so on, or the like; a so-called solution suspension method, wherein a binder resin, a colorant and so on are dissolved in an organic solvent to obtain an organic solvent solution, a droplet is formed with the organic solvent solution in an aqueous dispersion medium containing a dispersion stabilizer followed by removal of the organic solvent; or the like.

Also, in the present invention, “an amount of adsorbed moisture” means a ratio of an amount of change from a base weight of a toner to a weight of the toner after environmental change with respect to the base weight. Specifically, the base weight is a weight of the toner which is left under a condition of nearly 0% relative humidity (in the present invention, a relative humidity of 0.7% or less) at a predetermined temperature (in the present invention, 10° C., 23° C. or 32° C.) so as to be in a stable state without weight fluctuation. The weight of the toner after environmental change is a weight of the toner which is left under a different humidity (in the present invention, corresponding to the above-mentioned temperatures, respectively 20° C., 50° C. or 80° C.) from the above humidity at the temperature unchanged so as to have the moisture adsorbed or desorbed on the surface of the toner and be in a stable state without weight fluctuation. A ratio of the amount of change from the base weight of the toner to the weight of the toner after environmental change with respect to the base weight is the amount of adsorbed moisture.

Herein, the moisture adsorbed on the surface of the toner may remain on the surface of the toner under the condition that the humidity is near to 0%. However, the moisture remaining on the surface of the toner under the condition can be ignored in the present invention since the amount of the moisture is extremely small.

The amount of adsorbed moisture can be measured, for example, by means of an adsorption-desorption measuring device such as IGAsorp Moisture Sorption Analyser (manufactured by HIDEN ANALYTICAL Ltd.) or the like by the following method.

In a preliminarily dried chamber, a sampling jig is set and a toner of 30 to 40 mg is weighed precisely. At the above-mentioned predetermined temperature, a relative humidity in the chamber is controlled to 0.7% or less. Then, a toner weight is obtained when a weight fluctuation rate of the toner becomes constantly within±0.3% and referred to as a base weight W1 of the toner. Next, at the temperature unchanged, the toner is left for 10 minutes or more at the relative humidity different from the above relative humidity and corresponding to the above-mentioned predetermined temperature so as to have moisture adsorbed or desorbed on the surface of the toner. When the weight of the toner becomes stable again, a weight W2 of the toner (toner weight after environmental change) is measured. The amount of adsorbed moisture is obtained by the following calculating formula.

Calculating formula:
an amount of adsorbed moisture (wt %)=100× (W2−W1−W3)/W1
wherein, W3 is a value of an amount of adsorbed moisture of the sampling jig under the environment in measurement (including temperature and humidity).

The weight fluctuation rate is a fluctuation amount of a toner weight in percentage with respect to a base weight, wherein the base weight is an average value of toner weights measured periodically within a specified time in a chamber dried at the predetermined temperature and a relative humidity of 0.7% or less, and wherein the toner weight (herein, referred to as a toner weight after fluctuation) is measured after measurement for the base weight. The weight fluctuation rate can be represented by the following formula.

Calculating formula:
a weight fluctuation rate (%)=100× (“base weight”−“toner weight after fluctuation”)/base weight.

In the present invention, in order to objectively specify the moisture adsorption property of the non-magnetic toner for developing electrostatic image of the present invention, a standard state and typical conditions of environments of high temperature and humidity, normal temperature and humidity, and low temperature and humidity are set as follows.

(1) A standard state: environment having a temperature of 10° C., 23° C. or 32° C. and a relative humidity of 0.7% or less.

(2) A typical environment of high temperature and humidity: environment having a temperature of 32° C. and a relative humidity of 80%.

(3) A typical environment of normal temperature and humidity: environment having a temperature of 23° C. and a relative humidity of 50%.

(4) A typical environment of low temperature and humidity: environment having a temperature of 10° C. and a relative humidity of 20%.

However, in the present invention, the above standard states of three temperatures can be equally considered since the humidity of the above conditions is 0.7% or less (substantially 0%) and the base weights under the standard states at the various temperatures are the same or the difference is very small (within the range of measurement error).

The amount of adsorbed moisture of the non-magnetic toner for developing electrostatic image of the present invention under the typical environment of high temperature and humidity with respect to the amount of adsorbed moisture in the standard state may be preferably from 0.1 to 0.25 wt %, more preferably from 0.12 to 0.23 wt %.

If the above-mentioned amount of adsorbed moisture under the typical environment of high temperature and humidity exceeds the above range, a charge amount of the toner under the condition of high temperature and humidity may decline.

On the other hand, if the above-mentioned amount of adsorbed moisture under the typical environment of high temperature and humidity is less than the above range, excess in a charge amount of the toner under the condition of high temperature and humidity may occur.

The amount of adsorbed moisture of the non-magnetic toner for developing electrostatic image of the present invention under the typical environment of normal temperature and humidity with respect to the amount of adsorbed moisture at the standard state may be preferably from 0.05 to 0.18 wt %, more preferably from 0.07 to 0.16 wt %.

If the above-mentioned amount of adsorbed moisture under the typical environment of normal temperature and humidity exceeds the above range, a charge amount of the toner under the condition of normal temperature and humidity may decline.

On the other hand, if the above-mentioned amount of adsorbed moisture under the typical environment of normal temperature and humidity is less than the above range, excess in a charge amount of the toner under the condition of normal temperature and humidity may occur.

It is preferable that the difference between the amount of adsorbed moisture under the typical environment of high temperature and humidity and the amount of adsorbed moisture under the typical environment of normal temperature and humidity (“the amount of adsorbed moisture at 32° C. and a relative humidity of 80%”−“the amount of adsorbed moisture at 23° C. and a relative humidity of 50%”) is 0.15 wt % or less, and more preferably 0.12 wt % or less. If the difference between the amount of adsorbed moisture under the typical environment of high temperature and humidity and the amount of adsorbed moisture under the typical environment of normal temperature and humidity is within the above range, it means that the toner is excellent in environmental stability under all types of environment.

It is preferable that a dispersion state of a colorant particle of the non-magnetic toner for developing electrostatic image of the present invention on the section of the toner meets the following conditions since the amount of adsorbed moisture of the toner can be easily controlled within the above range of the amount of adsorbed moisture:

(1) a dispersion average particle diameter of the colorant particle is 80 nm or less; and

(2) a number based percentage of the colorant particle with a particle diameter of 400 nm or more is 5% or less.

If the dispersion average particle diameter of the colorant particle exceeds the above range or the percentage of the colorant particle having a particle diameter of 400 nm or more exceeds the above range, a sufficient printing density cannot be obtained, and thus a high quality image cannot be formed.

When the dispersion state of the colorant particle meets the above ranges, the amount of adsorbed moisture can be easily controlled within the above range since a component contained in the colored particle except a colorant particle, for instance, a charge control agent or the like can be dispersed uniformly.

As for the method of measuring the dispersion state of the above colorant particle on the section of the toner, for example, a section of a toner can be observed by examining a toner particle which is made to be able to disperse an electron by a negative staining method, a metal shadowing method or the like by means of a transmission electron microscope (TEM).

In order to have the dispersion state of the above colorant particle on the section of the toner be within the above range, in a method of producing a toner by the polymerization method to be hereinafter described, providing a polymerizable monomer composition with a dispersion process may be preferred. Specifically, the polymerizable monomer composition is preliminarily dispersed by means of an emulsifying and dispersing machine or the like followed by dispersing the polymerizable monomer composition by means of a media type dispersing machine. By performing the above process, the colorant particle is uniformly dispersed and made to be a fine particle. Thereby, the dispersion state of the colorant particle can be adjusted to the desired condition.

As for the non-magnetic toner for developing electrostatic image of the present invention, to control the amount of adsorbed moisture at 32° C. and a relative humidity of 80%, the amount of adsorbed moisture at 23° C. and a relative humidity of 50%, and further the difference between the amounts of adsorbed moisture under the two environments within the above-mentioned preferable ranges, there may be the above-mentioned method of adjusting the dispersion state of the colorant particle by the dispersion process and further, for example, various methods to be hereinafter described.

(1) By specifying the kinds and added amount of a charge control agent to be hereinafter described, the amount of adsorbed moisture can be controlled within a preferable range. Specifically, a charge control resin having a specific functional group is preferable.

(2) In a method of producing a toner to be hereinafter described, by filtering, washing, dewatering, and drying the colored particle obtained by the method including the process of forming a droplet in an aqueous dispersion medium containing the dispersion stabilizer, the amount of adsorbed moisture can be controlled within the above-mentioned range.

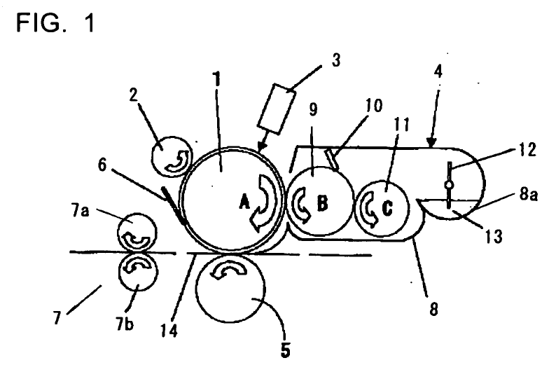

As for the non-magnetic toner for developing electrostatic image of the present invention, it is preferable that the absolute value of a charge amount |Q/M| of a toner on the surface of a developing roller (see the symbol 9 in FIG. 1) under all types of environments is within the range from 10 to 70 μC/g, and more preferably from 15 to 65 μC/g.

Herein, the charge amount Q/M of a toner on the surface of a developing roller is the charge amount of unit weight of the toner attached on the developing roller after an exposure process before a developing process in a use situation. The charge amount of the toner on the surface of the developing roller can be obtained by measuring a charge amount of a toner developed on the developing roller after plain pattern printing of the first page is performed using a printer followed by stopping plain pattern printing of the second page halfway by means of, for example, a suction type Q/m analyzer (product name: 210HS-2A; manufactured by Trek Japan KK.).

Also, as for the non-magnetic toner for developing electrostatic image of the present invention, a ratio of the toner charge amount on the surface of the above-mentioned developing roller (toner charge amount at 10° C. and a relative humidity of 20%/toner charge amount at 32° C. and a relative humidity of 80%) under the above-mentioned typical environment of low temperature and humidity (a temperature of 10° C. and a relative humidity of 20%) and the above-mentioned typical high temperature and humidity (a temperature of 32° C. and a relative humidity of 80%) may be preferably from 1.0 to 3.5, more preferably 1.0 to 2.0, most preferably from 1.0 to 1.5.

If the ratio of the toner charge amounts exceeds the above-mentioned range, a fog may be generated under the environment of high temperature and humidity or printing soiling may be generated under the environment of low temperature and humidity.

Hereinafter, the component materials and production method of the non-magnetic toner for developing electrostatic image of the present invention will be explained in detail.

The non-magnetic toner for developing electrostatic image of the present invention contains a colored particle and may contain other particles and components such as an external additive which adheres on the surface of the colored particle, a carrier which is a particle to support the colored particle or the like, if required.

The colored particle in the toner contains a binder resin and a colorant, and may contain other components such as a charge control agent, a release agent or the like, if necessary.

As the binder resin to be contained in the colored particle, resins conventionally used as a binder resin of a toner can be used. For example, there may be a polymer of styrene or substitution derivatives thereof such as polystyrene, polyvinyl toluene or the like; a styrene copolymer such as a styrene-methyl acrylate copolymer, a styrene-butyl acrylate copolymer, a styrene-2-ethylhexyl acrylate copolymer, a styrene-methyl methacrylate copolymer, a styrene-ethyl methacrylate copolymer, a styrene-butyl methacrylate copolymer, a styrene-butadiene copolymer or the like; polymethyl methacrylate, polyester, an epoxy resin, polyvinyl butyral, an aliphatic or alicyclic hydrocarbon resin, polyolefin, a methacrylate resin, an acrylate resin, a norbornene resin, and a hydrogenated product of the above-mentioned styrene based resin, or the like.

As the colorant, various pigments can be used if meeting the above-mentioned dispersion state.

To obtain a monochrome toner, as a black colorant, for example, carbon black, titan black or the like may be used.

To obtain a full-color toner including a yellow toner, a magenta toner and a cyan toner, a yellow colorant, a magenta colorant and a cyan colorant can be used respectively.

As the yellow colorant, for example, a compound such as an azo based pigment, a condensed polycyclic based pigment or the like can be used. Specifically, there may be C. I. Pigment Yellow 3, 12, 13, 14, 15, 17, 62, 65, 73, 74, 75, 83, 90, 93, 97, 120, 138, 155, 180, 181, 185, 186 or the like.

As the magenta colorant, for example, a compound such as an azo based pigment, a condensed polycyclic based pigment or the like can be used. Specifically, there may be C. I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209 or 251, C. I. Pigment Violet 19 or the like.

As the cyan colorant, for example, a phthalocyanine compound such as a copper phthalocyanine compound or the like and the derivative thereof, an anthraquinone compound or the like can be used. Specifically, there may be C. I. Pigment Blue 2, 3, 6, 15, 15:1, 15:2, 15:3, 15:4, 16, 17, 60 or the like.

The amount of the colorant is preferably from 1 to 10 parts by weight with respect to the binder resin of 100 parts by weight.

It is preferable that the colored particle contains the charge control agent. As the charge control agent, charge control agents which are conventionally used for the toner can be used without limit. The charge control agents can be classified into a charge control agent having a negatively charging ability and a charge control agent having a positively charging ability. In the present invention, the charge control agent is selected depending on whether the toner of the present invention is to be a toner having a negatively charging ability or a toner having a positively charging ability.

Among the charge control agents, a charge control resin may be preferably used. The charge control resin is suitable for obtaining a toner having the amount of adsorbed moisture specified in the present invention. The charge control resin has high compatibility with a binder resin, no color, and capability to obtain a toner having a stable charge property during high-speed color continuous printing.

Hereinafter, a charge control resin having a negatively charging ability and a charge control resin having a positively charging ability will be explained.

As the charge control resin having a negatively charging ability, there may be a resin which has a substituent selected from a group consisting of a carboxyl group or the salt thereof, a phenol group or the salt thereof, a thiophenol group or the salt thereof and a sulfonic acid group or the salt thereof in a polymer side chain, or the like.

Among them, the resin having a sulfonic acid group or the salt thereof in a polymer side chain is preferably used. Specifically, there may be a resin obtained by copolymerization of a monovinyl monomer containing a sulfonic acid group or the salt thereof and other monovinyl monomer which is copolymerizable with the monovinyl monomer.

A compounding amount of the monovinyl monomer containing a sulfonic acid group or the salt thereof in the charge control resin having a negatively charging ability is preferably from 0.5 to 5 wt %, more preferably from 1 to 3 wt %. If the compounding amount of the monovinyl monomer containing a sulfonic acid group or the salt thereof is less than the above range, a charge amount of the toner may become insufficient. If the compounding amount of the monovinyl monomer containing a sulfonic acid group or the salt thereof exceeds the above range, a decline in a charge amount of the toner at high temperature and humidity becomes large so that a fog can be generated.

As the charge control resin having a negatively charging ability, a charge control resin having a negatively charging ability having a weight average molecular weight of 2,000 to 50,000 may be preferable, more preferably from 4,000 to 40,000, and most preferably from 6,000 to 35,000.

A glass transition temperature of the charge control resin having a negatively charging ability is preferably from 40 to 80° C., more preferably from 45 to 75° C., and most preferably from 45 to 70° C. If the glass transition temperature is less than the above range, shelf stability of the toner may decrease. If the glass transition temperature exceeds the above range, fixing ability may lower.

Also, since controlling the amount of adsorbed moisture of the toner within the desired range becomes easy, an acid value of the charge control resin having a negatively charging ability may be preferably from 0.5 to 20 mg KOH/g, more preferably from 1 to 12 mg KOH/g.

As the charge control resin having a positively charging ability, for example, there may be a resin containing an amino group such as —NH₂, —NHCH₃, —N(CH₃)₂, —NHC₂H₅, —N(C₂H₅)₂, —NHC₂H₄OH or the like, and a resin containing a functional group having an ammonium chloridized amino group. Such a resin can be obtained by copolymerization of a monovinyl monomer containing an amino group and a monovinyl monomer which is copolymerizable therewith. Also, the resin can be obtained by ammonium chloridizing the copolymer obtained by the above method. Further, the resin can be obtained by copolymerization of a monovinyl monomer containing an ammonium salt group and a monovinyl monomer which is copolymerizable therewith. However, the method of obtaining such a resin is not limited thereto.

A compounding amount of the monovinyl monomer having a functional group such as an amino group, an ammonium salt group or the like in the charge control resin having a positively charging ability is preferably from 0.5 to 5 wt %, more preferably from 1 to 3 wt %. If the compounding amount of the monovinyl monomer having the functional group is less than the above range, a charge amount of the toner may become insufficient. If the compounding amount of the monovinyl monomer having the functional group exceeds the above range, a decline in a charge amount of the toner at high temperature and humidity becomes large so that a fog can be generated.

As the charge control resin having a positively charging ability, a charge control resin having a positively charging ability having a weight average molecular weight of 2,000 to 30,000 may be preferable, more preferably from 4,000 to 25,000, and most preferably from 6,000 to 20,000.

A glass transition temperature of the charge control resin having a positively charging ability is preferably from 40 to 100° C., more preferably from 45 to 80° C., and most preferably from 45 to 70° C. If the glass transition temperature is less than the above range, shelf stability of the toner may decrease. If the glass transition temperature exceeds the above range, fixing ability may lower.

A compounding amount of the charge control agent is preferably from 0.1 to 10 parts by weight, more preferably from 0.2 to 5 parts by weight, with respect to the polymerizable monomer used to obtain the binder resin of 100 parts by weight. If the compounding amount of the charge control agent is less than the above range, an image may not be formed. If the compounding amount of the charge control agent exceeds the above range, a fog can be generated.

The colored particle may preferably contain a release agent. As the release agent, for example, there may be a polyolefin wax such as low-molecular-weight polyethylene, low-molecular-weight polypropylene, low-molecular-weight polybutylene or the like; a natural wax such as candelilla, a carnauba wax, a rice wax, a haze wax, jojoba or the like; a petroleum wax such as paraffin, microcrystalline, petrolactam or the like, and a modified wax thereof; a synthesized wax such as a Fischer-Tropsch wax or the like; a multifunctional esterified compound such as pentaerythritol tetramyristate, pentaerythritol tetrastearate, pentaerythritol tetrapalmitate, dipentaerythritol hexamyristate, dipentaerythritol hexastearate or the like; and so on.

The release agent may be used alone or in combination with two or more kinds.

A compounding amount of the release agent is generally from 0.5 to 50 parts by weight, and preferably from 1 to 20 parts by weight, with respect to the binder resin of 100 parts by weight.

It is preferable that the colored particle is a so-called core-shell type particle, which can be obtained by using two different polymers, one for the inside of the particle (a core layer) and another for the outside of the particle (a shell layer), in combination. The core-shell type particle can balance lowering the minimum fixing temperature and shelf stability of the toner by covering the low-softening point substance inside (a core layer) with the substance having a higher-softening point.

The method of producing the core-shell type particle may be preferably a method of forming a shell layer by an in situ method on a particle to be a core layer produced by a polymerization method.

A colored particle can be produced by conventionally known methods such as a polymerization method including the emulsion polymerization agglomeration method, the suspension polymerization method or the like; the solution suspension method; the phase inversion emulsifying method and so on. Among the production methods, producing a colored particle by the polymerization method is preferable since a colored particle having an average circularity of 1, that is, close to an absolute sphere, and a sharp particle size distribution can be obtained.

Among the polymerization methods, the non-magnetic toner for developing electrostatic image of the present invention is preferably produced by the suspension polymerization method.

In the polymerization method, a colorant and, if necessary, other components such as a charge control agent, a release agent or the like are dissolved or dispersed in a polymerizable monomer which is a material of a binder resin so as to prepare a polymerizable monomer compound. After a process by which the polymerizable monomer composition is dispersed, the polymerizable monomer composition is added in an aqueous dispersion medium containing a dispersion stabilizer. Thereto, a polymerization initiator is added and a droplet of the polymerizable monomer compound is formed. The droplet is subject to polymerization, and particles are associated with each other, if required. Next, filtering, washing, dewatering and drying are performed to produce a colored particle.

Particularly, to produce a core-shell type colored particle, by a conventionally known method such as a spray dry method, an interface reaction method, an in situ polymerization method, a phase separation method or the like, a shell layer is covered on a core layer which is the colored particle produced by one of the above methods. It is preferable that the shell layer is covered by the in situ polymerization method on the colored particle produced by the polymerization method.

As the polymerizable monomer which is a material of the binder resin, a monovinyl monomer, and if required, a crosslinkable monomer, a crosslinkable polymer, a macromonomer and other monomers are used. The polymerizable monomers are subject to polymerization so as to be the binder resin component in the colored particle.

As the monovinyl monomer, for example, there may be an aromatic vinyl monomer such as styrene, vinyl toluene, α-methyl styrene or the like; a (meth)acrylic acid based monomer such as (meth)acrylic acid, methyl (meth)acrylate, ethyl (meth)acrylate, propyl (meth)acrylate, butyl (meth)acrylate, 2-ethylhexyl (meth)acrylate, cyclohexyl (meth)acrylate, isobornyl (meth)acrylate, dimethyl aminoethyl (meth)acrylate, (meth)acrylamide or the like; a monoolefin monomer such as ethylene, propylene, butylene or the like; and so on. In the present invention, “(meth)acrylic acid” refers to “methacrylic acid and acrylic acid”.

The above monovinyl monomer can be used alone or in combination of two or more kinds. Among the monovinyl monomers, the aromatic vinyl monomer alone or a combination of the aromatic vinyl monomer and the (meth)acrylic acid based monomer is preferably used.

In order to improve hot offset, it is preferable to use a desired crosslinkable monomer with a monovinyl monomer. The crosslinkable monomer is a monomer having two or more polymerizable functional groups.

Further, it is preferable to use a macromonomer as a part of the polymerizable monomer so that shelf stability and fixing ability at a low temperature are well-balanced. The macromonomer is a reactive oligomer or polymer which has a polymerizable carbon-carbon unsaturated double bond at the end of a polymer chain and a number average molecular weight of 1,000 to 30,000 generally.

A macromonomer which provides a polymer having higher Tg than that of a polymer obtained by polymerization of the monovinyl monomer is preferable. An amount of the macromonomer is generally from 0.01 to 10 parts by weight, preferably from 0.03 to 5 parts by weight, more preferably from 0.05 to 1 part by weight, with respect to the monovinyl monomer of 100 parts by weight.

As the dispersion stabilizer, there may be an inorganic compound which is soluble in acid or alkali such as a metallic compound or the like including sulfate such as barium sulfate, calcium sulfate or the like; carbonate such as barium carbonate, calcium carbonate, magnesium carbonate or the like; phosphate such as calcium phosphate or the like; metal oxide such as aluminum oxide, titanium oxide or the like; metal hydroxide such as aluminum hydroxide, magnesium hydroxide, ferric hydroxide or the like.

In the present invention, as the polymerization initiator, which polymerizes the polymerizable monomer composition, there may be persulfate or organic peroxide.

Further, upon polymerization, a use of the molecular weight modifier is preferable. As the molecular weight modifier, there may be mercaptans such as t-dodecyl mercaptan, n-dodecyl mercaptan, n-octyl mercaptan, 2,2,4,6,6-pentamethylheptane-4-thiol or the like. The molecular weight modifier can be added before or during polymerization. An amount of the molecular weight modifier is preferably from 0.01 to 10 parts by weight, more preferably from 0.1 to 5 parts by weight, with respect to the monovinyl monomer of 100 parts by weight.

As a polymerizable monomer for shell, the above-mentioned polymerizable monomer or the like can be similarly used. Among them, a monomer which provides a polymer having Tg of more than 80° C. or more such as styrene, acrylonitrile, methyl methacrylate or the like is preferable to be used alone or in combination with two or more kinds.

As a polymerization initiator used for polymerization of the polymerizable monomer for shell, there may be water-soluble polymerization initiators such as a metal persulfate including potassium persulfate, ammonium persulfate or the like; an azo initiator such as 2,2′-azobis(2-methyl-N-(2-hydroxyethyl)propionamide), 2,2′-azobis-(2-methyl-N-(1,1-bis(hydroxymethyl)2-hydroxyethyl)propionamide) or the like, and so on. An amount of the polymerization initiator, with respect to the polymerizable monomer for shell of 100 parts by weight, is preferably from 0.1 to 30 parts by weight, more preferably from 1 to 20 parts by weight.

In the present invention, the colored particle, preferably the core-shell type colored particle, obtained by the above method can be used alone or with an external additive attached as a one-component non-magnetic toner for developing electrostatic image. Further, the colored particle can be used as a two-component non-magnetic toner for developing electrostatic image by mixing with a carrier by means of a high-speed agitator such as a V type mixer or the like.

By making the external additive attach to or bury in the surface of the colored particle, charge property, flowability, shelf stability or the like of the toner can be controlled.

As the external additive, external additives which have been conventionally used for the toner can be used without limit, and for example, there may be an inorganic particle and an organic resin particle. As the inorganic particle, there may be a particle of silica, aluminum oxide, titanium oxide, zinc oxide, tin oxide or the like. As the organic resin particle, there may be a (meth)acrylate ester polymer particle, a styrene-(meth)acrylate ester copolymer particle or the like. Among the above, silica or titanium oxide may be suitable, a particle of silica or titanium oxide, the surface of which is subjected to a hydrophobicity-imparting treatment, may be more preferable, and a particle of silica which is subjected to a hydrophobicity-imparting treatment may be most preferable.

An amount of the external additive is generally from 0.1 to 6 parts by weight with respect to the colored particle of 100 parts by weight, but may not be limited thereto.

As the carrier to be mixed with the colored particle, carriers which have been conventionally used for the toner can be used without any limit. For example, there may be glass beads, glass beads which are surface-treated with a fluorine resin, a styrene/acrylic resin or a silicone resin or the like, and so on.

In case of a two-component toner, density of a colored particle in a toner is generally from 0.1 to 50 wt %, preferably from 0.5 to 15 wt %, more preferably from 3 to 10 wt %.

In the present invention, from the viewpoint of improving an image quality such as image reproducibility, fineness or the like, a toner which has a shape close to sphericity, a small particle diameter and a sharp particle size distribution may be preferable to use.

A volume average particle diameter (Dv) of the toner in the present invention is controlled from 3 to 10 μm, more preferably from 5 to 8 μm. If Dv is less than the above range, a toner may leak from a sealing portion and soil inside of an image forming device. Further, decrease in a flowability of the toner, generation of a fog, decrease in transferability of the toner or decrease in a cleaning property may occur. On the other hand, if Dv exceeds the above range, thin line reproductivity may decline so that high-quality images cannot be obtained or fixing ability may lower.

An average circularity (Ca) of the toner is preferably from 0.950 to 0.995, more preferably from 0.960 to 0.990, most preferably from 0.970 to 0.990.

In the present invention, the circularity is a value obtained by dividing a perimeter of a circle having the same area as a projected image of a particle by a perimeter of the projected image of the particle. Also, the circularity is used as a simple method of presenting a shape of a particle quantitatively and is an indicator showing the level of convexo-concave shapes of the toner. The average circularity is “1” when the toner is an absolute sphere, and becomes smaller as the shape of the surface of the toner becomes more complex. In order to obtain the average circularity (Ca), firstly, a circularity (Ci) of each of measured “n” particles of 1 μm or more by a diameter of the equivalent circle is calculated by the following formula:
Circularity (Ci)=a perimeter of a circle having the same area as a projected area of a particle/a perimeter of the projected image of the particle
Next, the average circularity (Ca) is obtained by the following formula:

$$average circularity = ( {\sum }_{i = 1}^{n} ( Ci \times fi ) ) / {\sum }_{i = 1}^{n} ( fi )$$

wherein, “fi” is a frequency of a particle of the circularity (Ci).

The above average circularity is measured by means of a flow particle image analyzer (product name: FPIA-1000 or FPIA-2100; manufactured by Sysmex Co.).

FIG. 1 shows an example of a constitution of an image forming device to which the non-magnetic toner for developing electrostatic image, which is provided by the present invention, is applied. In FIG. 1, an electrophotographic apparatus shown in FIG. 1 has a photosensitive dram 1 as a photosensitive member, and the photosensitive dram 1 is mounted so as to be able to rotate freely in the direction of an arrow “A”. The photosensitive dram 1 comprises a conductive support dram member and a photoconductive layer provided on the conductive support dram. The photoconductive layer is formed of, for example, an organic photoconductor, a selenium photoconductor, a zinc oxide photoconductor, an amorphous silicon photoconductor or the like. Among them, the organic photoconductor is preferable. The photoconductive layer is bound to the conductive support dram. As a resin used to bind the photoconductive layer to the conductive support dram, for example, there may be a polyester resin, an acrylic resin, a polycarbonate resin, a phenolic resin, an epoxy resin or the like. Among them, the polycarbonate resin is preferable.

Around the photosensitive dram 1 along the circumferential direction thereof, a charging roller 2 as a charging member, a light radiation device 3 as exposure equipment, a development device 4, a transfer roller 5 and a cleaning blade 6 are arranged.

Also, on the downstream side of the conveying direction of the photosensitive dram 1 and the transfer roller 5, a fixing device 7 is provided. The fixing device 7 comprises a heating roller 7a and a support roller 7b.

The conveying route of a recording material 14 is provided so that the recording material is conveyed between the photosensitive dram 1 and the transfer roller 5, and between the heating roller 7a and the support roller 7b.

A development device 4 is a development device used for a one-component contact developing method, comprising a developing roller 9, a blade 10 for the developing roller which is to scrape off an excess toner on the developing roller, a supply roller 11 and a stirring vane 12 to stir the toner in a casing 8 in which a toner 13 is stored.

A method of forming an image with the use of the image forming device as shown in FIG. 1 comprises processes of a charging process, an exposuring process, a developing process, a transferring process, a cleaning process and a fixing process as follows.

The charging process is a process to charge positively or negatively the surface of the photosensitive dram 1 uniformly. As the charging method with the use of the charged member, there may be the charging roller 2 as shown in FIG. 1, and also a contact charging method, which uses a fur brush, a magnetic brush, a blade or the like to charge, and a non-contact charging method, which uses corona discharge. It is possible to replace the charging roller 2 by such a contact charging method or non-contact charging method.

The exposure process is a process to radiate light corresponding to image signal on the surface of the photosensitive dram 1 by means of the light radiation device 3 as an exposure device as shown in FIG. 1, and to form a latent image of electrostatics on the surface of the photosensitive dram 1 charged uniformly. As such a light radiation device 3, for example, there may be a laser radiation apparatus and a LED radiation apparatus.

The developing process is a process to attach the toner to the latent image of electrostatics formed on the surface of the photosensitive dram 1 in the exposure process by means of the development device 4 so as to form the visible image. The toner is attached only to a light radiated part in the case of reversal, and the toner is attached only to a light non-radiated part in the case of normal development.

In the development device 4 used for a one-component contact developing method, the stirring vane 12 is furnished in a toner vessel 8 formed on the upper stream side of the toner supply direction of the casing 8 to agitate the toner 13.

The developing roller 9 is disposed to partially contact the photosensitive dram 1, and rotates in the direction “B” opposite to the direction of the photosensitive dram 1. The supply roller 11 rotates in the direction “C” similarly to the direction of the developing roller 9 in contact with the developing roller 9. The toner 13 is supplied from the toner vessel 8a by the stirring vane 12 to the supply roller 11 and is attached to the outer periphery of the supply roller 11. Then, the supply roller 11 supplies the toner to the outer periphery of the developing roller 9. As other developing methods, there may be a one-component non-contact developing method, a two-component contact developing method and a two-component non-contact developing method.

At a position of the outer periphery of the developing roller 9 between a contact point of the developing roller 9 with the supply roller 11 and a contact point of the developing roller 9 with the photosensitive dram 1, a blade 10 for the developing roller as a toner layer thickness controlling member and a toner charged member is arranged. The blade 10 for the developing roller is made of, for example, a conductive rubber elastic body or metal.

The transferring process is a process to transfer the visible image formed on the surface of the photosensitive dram 1 by means of the development device 4 to the transferring material 14 such as paper or the like. Generally, as shown in FIG. 1, transfer is performed by means of the transfer roller 5. Besides the transfer roller 5, there may be a belt transfer and a corona transfer.

The cleaning process is a process of cleaning the toner remained on the surface of the photosensitive dram 1 after the transferring process. In the present invention, the cleaning blade 6 is arranged to closely contact the surface of the photosensitive dram 1 so as to scrape off the toner remained on the surface of the photosensitive dram 1. The scraped toner is generally collected by a collecting device (not shown).

In the image forming device as shown in FIG. 1, after the whole surface of the photosensitive dram 1 is uniformly charged negatively by the charging roller 2, a latent image of electrostatics is formed by means of the light radiation device 3. Further, a visible image is developed by means of the development device 4. Next, the visible image on the photosensitive dram 1 is transferred to the transferring material 14 such as paper or the like by means of the transfer roller 5. The toner not transferred and remained on the surface of the photosensitive dram 1 is cleaned by means of the cleaning blade 6. After that, a new image forming cycle begins.

The fixing process is a process to fix the visible image transferred to the transferring material 14. In the image forming device as shown in FIG. 1, at least one of the heating roller 7a heated by a heating means (not shown) and the support roller 7b is rotated, and the transferring material 14 passes therethrough so as to be heated and pressed.

Heating, pressing, heating and pressing, solvent vapor and so on are known as the fixing process. Among them, the above mentioned heating and pressing method by means of the heating roller is the most widely used method.

The image forming device shown in FIG. 1 is an image forming device for monochrome, however, the image forming method of the present invention can be applied to a color image forming device such as a copying machine or a printer which forms color images.

The above mentioned non-magnetic toner of the present invention is widely used for a developing system of a latent image of electrostatics, a developing method, an image forming device to develop a latent image having an electrostatic property of a latent image of electrostatics so as to form images of pictures, drawings, characters, symbols and so on in an electrophotography, an electrostatic recording method, an electrostatic printing process or the like.

Also, since the amount of the adsorbed moisture of the toner is specified, the polymerized toner for developing a latent image of electrostatics of the present invention becomes a non-magnetic toner which is excellent in environmental stability under various environments from low temperature and humidity to high temperature and humidity. Therefore, high quality printing with high image density can be performed.

### EXAMPLES

Hereinafter, the present invention will be explained further in detail with reference to examples and comparative examples. However, the scope of the present invention may not be limited to the following examples. Herein, “part(s)” and “%” are based on weight if not particularly mentioned. In the examples, the evaluating methods performed are as follows.

### Example 1

(Production of a Charge Control Agent)

2L flask equipped with an agitator, a condenser, a thermometer and a nitrogen introduction tube was charged with 300 g of methanol and 100 g of methyl ethyl ketone, and further 600 g of a mixture comprising 1.2 wt % acrylamide methylpropanesulfonic acid, 85 wt % styrene and 13.8 wt % 2-ethylhexyl acrylate and 12 g of azobisisobutyronitrile were charged. While stirring, solution polymerization was performed for 10 hours at 70° C. under introducing nitrogen. After the solution polymerization was completed, 60 g of sodium hydroxide (a 10 wt % methanol solution) was added to the solution, and then stirring for 1 hour at 70° C. was performed. Then, solvents such as methanol and methyl ethyl ketone were removed from the obtained solution, thus obtained a copolymer (a weight average molecular weight=18,000, Tg=70° C.) . The copolymer is referred to as a charge control agent A.

80 parts by weight of styrene, 20 parts by weight of butyl acrylate, 5.0 parts by weight of a magenta colorant (product name: FUJI FAST CARMIN528-1; manufactured by Fuji Pigment Co., Ltd.), which is a mixture of PR31 and PR150, and 0.25 parts by weight of an aluminate coupling agent (alkyl acetoacetate aluminum diisopropylate; product name: AL—M; manufactured by Ajinomoto Fine-Techno. Co., Inc.) were charged in a reactor and stirred. Then, the mixture was subjected to preliminary dispersion by means of an in-line type emulsifying and dispersing machine (product name: MILDER; manufactured by Ebara Corporation) under the condition of a peripheral speed of 23 m/s and a circulation frequency θ of 26 times. Further, dispersion was performed by means of a media type dispersing machine having a screen for media separation.

Next, 10 parts of styrene, 2 parts of the charge control agent “A”, 0.5 parts of a polymethacrylic acid ester macromonomer (product name: AA6; manufactured by Toagosei Co., Ltd.), 8 parts of dipentaerythritol hexamyristate, 1.5 parts of t-dodecyl mercaptan as a molecular weight modifier, and 0.5 parts of divinyl benzene as a crosslinkable monomer were added to 95.25 parts of the polymerizable monomer mixture obtained by the above-mentioned dispersion followed by stirring and dissolving so as to prepare a polymerizable monomer composition.

Separately, an aqueous solution of 8.6 parts sodium hydroxide dissolved in 50 parts of ion-exchanged water was gradually added into an aqueous solution of 15.4 parts magnesium chloride dissolved in 250 parts of ion-exchanged water while agitated. Thereby, a magnesium hydroxide colloid dispersion liquid was prepared. As a result of measuring the particle size distribution of the colloid by means of SALD particle size distribution measuring device (manufactured by Shimadzu Corporation), the particle diameter D50 (50% of the cumulative value of the number particle size distribution) was 0.35 μm, and D90 (90% of the cumulative value of the number particle size distribution) was 0.62 μm.

The polymerizable monomer composition was charged into thus obtained magnesium hydroxide colloid dispersion liquid and agitated. Thereto, as a polymerization initiator, 5 parts of t-butylperoxy-2-ethylhexanoate (product name: PERBUTYL O; manufactured by NOF Corporation) was added. Thereafter, a high shear stirring was performed at 15,000 rpm for 10 minutes by means of an in-line type emulsifying and dispersing machine (product name: MILDER; manufactured by Ebara Corporation) to form droplets of the polymerizable monomer composition.

The dispersion, in which the droplets of the polymerizable monomer composition are dispersed, was charged into the reactor furnished with stirring vanes. The temperature of the reactor was raised to 90° C. to polymerize. When a polymerization conversion rate reached almost 100% , at the same polymerization temperature, 1 part of methyl methacrylate as a polymerizable monomer for shell and 0.1 parts of 2,2′-azobis[2-methyl-N-(2-hydroxyethyl)propion amide] (product name: VA086; manufactured by Wako Pure Chemical Industries, Ltd.) dissolved in 10 parts of ion-exchanged water were added. Polymerization was further continued for 3 hours at 90° C. and stopped. Thus, a dispersion of a colored particle was obtained. pH of the dispersion was 9.5.

The aqueous dispersion of the colored particle obtained as above was subject to acid washing in which sulfuric acid was added to be pH 6 or less while stirring. After dewatering by filtrating, ion-exchanged water were newly added by 500 parts to make slurry followed by washing with water. Thereafter, dewatering and washing with water was repeated for several times. After separating solid content by filtrating, drying at 40° C. by a dryer was performed for two days and nights, thus obtained a dried colored particle. 0.5 parts of a silica particle (a number average particle diameter of 12 nm) and 2.0 parts of a silica particle (a number average particle diameter of 40 nm) were added to 100 parts of thus obtained dried colored particle, and mixed by means of a Henschel mixer for 10 minutes at 1,400 rpm, thereby, a non-magnetic toner of Example 1 was obtained.

### Example 2

In the same manner as Example 1 except that the added amount of the charge control agent “A” was changed from 2 parts to 4 parts, a non-magnetic toner of Example 2 was obtained.

### Comparative Example 1

In the same manner as Example 1 except that 5 parts of a charge control resin having a negatively charging ability (a product having 7% of sulfonic acid functional group, product name: FCA626N; manufactured by Fujikura Kasei Co., Ltd.) was used instead of the charge control agent “A”, a non-magnetic toner of Comparative example 1 was obtained.

### Comparative Example 2

24 parts of toluene and 6 parts of methanol were dispersed in 100 parts of a charge control resin having a negatively charging ability (a product having 7% of sulfonic acid functional group, product name: FCA626N; manufactured by Fujikura Kasei Co., Ltd.), and then mixed and kneaded with a two roll while cooling without temperature rising.

After the charge control resin was wrapped around the rolls, 100 parts of magenta pigment (product name: FUJI FAST CARMIN528-1; manufactured by Fuji Pigment Co., Ltd.) was gradually added followed by mixing, kneading and dispersing. Thus obtained a charge control resin composition.

In the same manner as Example 1 except that 10 parts of the charge control resin composition (5 parts of which are a colorant) was used instead of the charge control agent “A” and the colorant, a non-magnetic toner of Comparative Example 2 was obtained.

In the examples, the testing methods performed are as follows.

Herein, LL environment refers to an environment at 10° C. and a humidity of 20%. NN environment refers to an environment at 23° C. and a humidity of 50%. HH environment refers to an environment at 32° C. and a humidity of 80%.

(1) Measurement of an Amount of Adsorbed Moisture

In order to measure an amount of adsorbed moisture of a toner, IGAsorp Moisture Sorption Analyser (manufactured by HIDEN ANALYTICAL Ltd.) was used. The specific measuring method is as follows.

Before measuring an amount of adsorbed moisture, inside of a chamber was dried by nitrogen flow of a flow amount of 400 to 500 ml/min for 3 hours or more at a predetermined temperature (in the present invention, 10° C., 23° C. or 32° C.) so as to dry the inside of a cell for measurement in the chamber at some level. A special sampling jig was placed, and then a toner of 30 to 40 mg was precisely weighed with a scale set inside of the chamber. Then, the chamber was closed to dry the inside of the chamber again by nitrogen flow of a flow amount of 400 to 500 ml/min until a relative humidity became 0.7% or less.

After drying, the flow amount of nitrogen flow was changed to 250 ml/min. An average value of toner weights in 10 minutes right before a desired time point was referred to as a base weight. Then, it was confirmed that the weight fluctuation rate of the toner was constantly within±0.3% compared with the base weight for 10 minutes from the desired time point and stable. The toner weight at the time point was referred to as “W1”. Next, at the temperature unchanged, the humidity was increased up to a predetermined relative humidity (in the present invention, 20%, 50% or 80% corresponding to each temperature mentioned above) and measurement of toner weight was started. After leaving the toner for 10 minutes or more from the start of measurement, a toner weight, when an accuracy of an actual measurement value became 98% or more with respect to an estimated measurement value obtained by polynomial approximation and stable, was referred to as “W2”. Also, an amount of adsorbed moisture of the sampling jig under environment of the same measuring condition was preliminarily confirmed and the value was referred to as “W3”. Based on these values, an amount of adsorbed moisture of a toner was calculated with the following formula:
amount of adsorbed moisture=100×(W2−W1−W3)/W1.
(2) Measurement of a Dispersion State of a Colorant particle by means of a transmission electron microscope

After evaporating and dyeing with ruthenium, the non-magnetic toner obtained in each Example and Comparative Example was wrapped in a photocurable resin to cure and cut at a room temperature. By means of a transmission electron microscope (product name: H7500; manufactured by Hitachi, Ltd.), a section of the toner including a toner having a diameter close to the volume average particle diameter of the toner (±10% volume average particle diameter) was photographed at 20,000-fold magnification. The obtained picture was analyzed with an image analysis software (product name: analysis) to obtain a dispersion average particle diameter of a colorant particle.

(3) Measurement Relating to a Particle Diameter

A volume average particle diameter (Dv) of a toner was measured by means of a particle diameter measuring device (product name: multicizer; manufactured by Beckman Coulter, Inc.) under the condition that the aperture diameter was 100 μm, the medium was Isotone II, and the number of the measured particles was 100,000.

(4) An Average Circularity of a Toner

In a container preliminarily filled with 0.02 g of toner, 0.02 g of a surfactant (alkyl benzene sulfonate) was charged as a dispersing agent followed by an ion-exchanged water of 10 ml and then was subjected to dispersion treatment by means of an ultrasonic disperser at 60 W for 3 minutes. A proper amount of ion-exchanged water was added so as to adjust a density of the toner at measurement to be 3,000 to 10,000 particles/μL. 1,000 to 10,000 colored particles of 1 μm or more by a diameter of the equivalent circle were subjected to measurement by means of a flow particle image analyzer (product name: FPIA-1000 or FPIA-2100; manufactured by Sysmex Co.) An average circularity was calculated based on the measured values.

Circularity can be calculated by the following formula, and the average circularity is an average value of circularity:
circularity=(a perimeter of a circle having the same area as a projected area of a particle)/(a perimeter of the projected image of the particle).
(5) Measurement of a Toner Charge Amount Q/M on a Surface of a Developing Roller

A commercially available printer of a non-magnetic one-component developing method (printing speed: 18 prints per minute) was used for evaluation. The printer was charged with printing papers and a toner and was left under HH or NN environment for one day (24 hours) followed by printing under HH or NN environment respectively.

After plain pattern printing of the first page was performed with the printer followed by stopping plain pattern printing of the second page halfway, the charge amount of the toner attached on the developing roller Q/M (μC/g) was measured by means of a suction type Q/m analyzer (product name: 210HS-2A; manufactured by Trek Japan Corporation). An absolute value of the charge amount is shown in Table 1.

(6) Printing test

The printer used in the above-mentioned (5) was charged with printing papers and a toner and was left under HH environment for one day (24 hours) to measure a fog as follows.

After plain pattern printing (0% printing density) of the first page was performed with the printer followed by stopping plain pattern printing of the tenth page halfway, a toner of a non-image area remained on the photosensitive member after developing was attached to an adhesive tape (product name: Scotch mending tape 810-3-18; manufactured by Sumitomo 3M Limited). The tape (a sample for measurement) was attached to a new printing paper, and color tone was measured by means of a spectrophotometer (product name: SE-2000; manufactured by NIPPON DENSHOKU INDUSTRIES CO., LTD.). As a reference (a benchmark sample), an unused adhesive tape was attached to a printing paper so as to measure color tone in the same manner. Each color tone was referred as coordinates of L*a*b*space, and color difference ΔE was calculated from color tones of the sample for measurement and the benchmark sample. The color difference ΔE was referred to as a fog value. Generation of a fog is small when the value is small. If the fog value ΔE (the color difference ΔE) is 1 or less, image quality is excellent.

[Results]

The results are shown in Table 1.

Notes in Table 1 are as follows:

*1: Abbreviations relating to the polymerizable monomers for core and shell: ST: styrene; BA: butyl acrylate; DVB: divinyl benzene; MMA: methyl methacrylate; and

*2: Abbreviations relating to the charge control agent: control agent A: charge control resin “A”; 626N: a sulfonic acid based charge control resin having a negatively charging ability (a product having 7% of sulfonic acid functional group, product name: FCA626N; manufactured by Fujikura Kasei Co., Ltd.).

TABLE 1

| | | | | | Comparative | Comparative |
|---|---|---|---|---|---|---|
| | | | Example 1 | Example 2 | Example 1 | Example 2 |
| Toner | Monomer for core (weight | | ST/BA/DVB | Same as | Same as | Same as |
| composition | ratio of added amount) *1 | | 80/20/0.5 | Example 1 | Example 1 | Example 1 |
| | Colorant | | 5 parts | Same as | Same as | Same as |
| | | | | Example 1 | Example 1 | Example 1 |
| | | Dispersion average | 46 | 38 | 52 | 95 |
| | | particle diameter (nm) | | | | |
| | | Number-based % of | 3.4 | 3.0 | 4.6 | 11.0 |
| | | colorant particle with | | | | |
| | | a particle diameter of | | | | |
| | | 400 nm or more | | | | |
| | Charge control agent *2 | | Control | Control | 626N | 626N |
| | | | Agent A | Agent A | (5 parts) | (5 parts) |
| | | | (2 parts) | (4 parts) | | |
| | Monomer for shell *1 | | MMA | Same as | Same as | Same as |
| | | | (1 part) | Example 1 | Example 1 | Example 1 |
| Toner | Amount of adsorption | | 0.15 | 0.18 | 0.68 | 0.54 |
| property | moisture (HH) (wt %) | | | | | |
| | Amount of adsorption | | 0.08 | 0.10 | 0.28 | 0.25 |
| | moisture (NN) (wt %) | | | | | |
| | Difference between amount | | 0.07 | 0.08 | 0.40 | 0.29 |
| | of adsorption Moisture | | | | | |
| | (HH − NN) (wt %) | | | | | |
| | Average circularity | | 0.978 | 0.980 | 0.976 | 0.974 |
| | Volume average particle | | 6.4 | 6.6 | 7.8 | 7.2 |
| | diameter (μm) | | | | | |
| | Toner charge amount \|Q/M\| | | 19 | 22 | 20 | 20 |
| | (μC/g) (HH) | | | | | |
| | Toner charge amount \|Q/M\| | | 24 | 29 | 78 | 66 |
| | (μC/g) (NN) | | | | | |
| | Toner charge amount ratio | | 1.3 | 1.3 | 3.9 | 3.3 |
| | (NN/HH) | | | | | |
| Evaluation | Fog value ΔE(HH) | | 0.2 | 0.4 | 23 | 18 |
| result | | | | | | |

### SUMMARY OF THE RESULTS

The fog value ΔE under HH environment of the non-magnetic toner in each of Examples 1 and 2 in the present invention, each of which has the amount of adsorbed moisture at 32° C. and a humidity of 80% within the range from 0.1 to 0.25 wt %, is 1.0 or less. Hence, image quality is excellent and it is shown that the toners of Examples 1 and 2 are excellent in environmental stability. On the other hands, the fog value of the non-magnetic toner in each of Comparative examples 1 and 2, each of which has the amount of adsorbed moisture out of the range of the present invention, widely exceeds 1.0, thus, deterioration in image quality is confirmed significantly.

What is claimed is:

1. A non-magnetic toner for developing electrostatic image comprising a colored particle, produced by a method comprising a step of forming a droplet in an aqueous dispersion medium containing a dispersion stabilizer, wherein a volume average particle diameter of the toner for developing electrostatic image is from 3 to 10 μm and an amount of adsorbed moisture of the non-magnetic toner for developing electrostatic image at 32° C. and a relative humidity of 80% is from 0.1 to 0.25 wt %.

2. A non-magnetic toner for developing electrostatic image according to claim 1, wherein an amount of adsorbed moisture at 23° C. and a relative humidity of 50% is from 0.05 to 0.18 wt %.

3. A non-magnetic toner for developing electrostatic image according to claim 2, wherein a difference between the amount of adsorbed moisture at 32° C. and the relative humidity of 80% and the amount of adsorbed moisture at 23° C. and the relative humidity of 50% is 0.15 wt % or less.

4. A non-magnetic toner for developing electrostatic image according to claim 1, wherein a dispersion state of a colorant particle on the section of the colored particle meets the following conditions (1) and (2):
(1) a dispersion average particle diameter of the colorant particle is 80 nm or less; and
(2) a number-based percentage of the colorant particle having a particle diameter of 400 nm or more is 5% or less.

5. A non-magnetic toner for developing electrostatic image according to claim 1, wherein the colored particle is produced by a suspension polymerization method and an average circularity of the colored particle is from 0.95 to 0.995.

6. A non-magnetic toner for developing electrostatic image according to claim 1, wherein an absolute value of a charge amount |Q/M| of the toner is in the range from 10 to 70 μC/g.

7. A non-magnetic toner for developing electrostatic image according to claim 6, wherein a ratio of a charge amount of the toner at 10° C. and a relative humidity of 20% with respect to a charge amount of the toner at 32° C. and a relative humidity of 80% is in the range from 1.0 to 3.5.
